(19) United States
(12) Patent Application Publication
(10) Pub. No.: US 2016/0086479 A1
(43) Pub. Date: Mar. 24, 2016

(54) METHOD FOR CONTROLLING ALARM AND ELECTRONIC DEVICE SUPPORTING THE SAME

(71) Applicant: Samsung Electronics Co., Ltd., Suwon-si (KR)

(72) Inventors: Byunghyun KANG, Suwon-si (KR); Minsung EO, Anyang-si (KR)

(21) Appl. No.: 14/851,650

(22) Filed: Sep. 11, 2015

(30) Foreign Application Priority Data
Sep. 19, 2014 (KR) 10-2014-0125038

(51) Int. Cl. G08B 25/00

(52) U.S. Cl. CPC G08B 25/008

(57) ABSTRACT

An alarm controlling method and an electronic device supporting the same are provided. The alarm controlling method includes collecting alarm period information of at least one application, determining a reference alarm period for an alarm period, based on the collected alarm period information, and adjusting the alarm period of the at least one application to the reference alarm period.

### CROSS-REFERENCE TO RELATED APPLICATION(S)

This application claims the benefit under 35 U.S.C. §119(a) of a Korean patent application filed on Sep. 19, 2014 in the Korean Intellectual Property Office and assigned Serial number 10-2014-0125038, the entire disclosure of which is hereby incorporated by reference.

### TECHNICAL FIELD

The present disclosure relates to an alarm controlling method, and an electronic device that supports the same.

### BACKGROUND

Current electronic devices are capable of downloading various applications from an online market, and installing the same. An electronic device may download and install a social network service (SNS) application, an e-mail service application, an instant messenger (IM), a chat service application for a one-to-one chat and a group chat, and the like. The application may periodically transmit a packet to a server to maintain a connection although a corresponding network service is not used. Accordingly, the server may recognize that the electronic device is connected to the server.

The above information is presented as background information only to assist with an understanding of the present disclosure. No determination has been made, and no assertion is made, as to whether any of the above might be applicable as prior art with regard to the present disclosure.

### SUMMARY

When an electronic device is an idle state, the electronic device needs to be activated to transmit a packet to a server. When the electronic device is activated, a large amount of current is consumed instantly. Also, as the number of applications that need to transmit a packet to a server gradually increases, the number of times that the electronic device is activated is increased and thus, an amount of time in which the user is capable of using the electronic device may become shorter.

Aspects of the present disclosure are to address at least the above-mentioned problems and/or disadvantages and to provide at least the advantages described below. Accordingly, an aspect of the present disclosure is to provide an alarm controlling method and an electronic device supporting the same.

In accordance with an aspect of the present disclosure, a method of controlling an alarm of an electronic device is provided. The method includes collecting alarm period information of at least one application, determining a reference alarm period for an alarm period, based on the collected alarm period information, and adjusting the alarm period of the at least one application to the reference alarm period.

In accordance with another aspect of the present disclosure, an electronic device is provided. The electronic device includes a communication unit configured to transmit and receive a packet, a controller configured to collect alarm period information of at least one application, determine a reference alarm period for an alarm period based on the collected alarm period information, and adjust an alarm period of the at least one application based on the collected alarm period information, and a storage unit configured to store the alarm period information.

An alarm controlling method and an electronic device supporting the same according to an embodiment of the present disclosure adjusts an alarm period to reduce the number of times of wake-up, so that an amount of current consumed may be reduced.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments the present disclosure will be more apparent from the following description taken in conjunction with the accompanying drawings, in which:

FIG. 1 is a diagram illustrating an electronic device of a network environment according to various embodiments of the present disclosure;

FIG. 2 is a block diagram of an electronic device according to various embodiments of the present disclosure;

FIG. 3 is a block diagram of a program module according to various embodiments of the present disclosure.

FIG. 4 is a diagram illustrating a configuration of an electronic device according to various embodiments of the present disclosure;

FIG. 5 is a flowchart illustrating an alarm controlling method according to various embodiments of the present disclosure;

FIGS. 6A and 6B are diagrams illustrating an alarm controlling method according to various embodiments of the present disclosure;

FIGS. 7A and 7B are diagrams illustrating an alarm controlling method according to various embodiments of the present disclosure;

FIG. 8 is a flowchart illustrating an alarm controlling method according to various embodiments of the present disclosure; and

FIG. 9 is a diagram illustrating an alarm controlling method according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” which may be used in describing various embodiments of the present disclosure refers to the existence of a corresponding disclosed function, operation or component which may be used in various embodiments of the present disclosure and does not limit one or more additional functions, operations, or components.

In various embodiments of the present disclosure, the expression “or” or “at least one of A or/and B” includes any or all of combinations of words listed together. For example, the expression “A or B” or “at least A or/and B” may include A, may include B, or may include both A and B.

The expression “1”, “2”, “first”, or “second” used in various embodiments of the present disclosure may modify various components of the various embodiments but does not limit the corresponding components. For example, the above expressions do not limit the sequence and/or importance of the components. The expressions may be used for distinguishing one component from other components. For example, a first user device and a second user device indicate different user devices although both of them are user devices. For example, without departing from the scope of the present disclosure, a first structural element may be referred to as a second structural element. Similarly, the second structural element also may be referred to as the first structural element.

When it is stated that a component (e.g., a first component) is “coupled to” or “connected to” another component (e.g., a second component), the component may be directly coupled to the another component, or coupled to the another component through a new component (e.g., a third component)t. In contrast, when it is stated that a component (e.g., a first component) is “directly coupled to” or “directly connected to” another component (e.g., a second component), a new component (e.g., a third component) does not exist between the component and another component.

The terms used in describing various embodiments of the present disclosure are only examples for describing a specific embodiment but do not limit the various embodiments of the present disclosure. Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present description.

The terms used in describing various embodiments of the present disclosure are only examples for describing a specific embodiment but do not limit the various embodiments of the present disclosure. Singular forms are intended to include plural forms unless the context clearly indicates otherwise. Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present description.

For example, the electronic device according to various embodiments of the present disclosure may be one or a combination of a smart phone, a tablet personal computer (PC), a mobile phone, a video phone, an e-book reader, a desktop PC, a laptop PC, a netbook computer, a personal digital assistant (PDA), a camera, a wearable device (e.g., a head-mounted-device (HMD) such as electronic glasses, electronic clothes, and electronic bracelet, an electronic necklace, an electronic appcessary, an electronic tattoo, and a smart watch.

According to some embodiments, the electronic device may be a smart home appliance. The smart home appliance may include at least one of a television (TV), a digital video disc (DVD) player, an audio player, an air conditioner, a cleaner, an oven, a microwave oven, a washing machine, an air cleaner, a set-top box, a TV box (e.g., Samsung HomeSync™, Apple TV™, or Google TV™), game consoles, an electronic dictionary, an electronic key, a camcorder, and an electronic frame.

According to some embodiments, the electronic device may include at least one of various types of medical devices (e.g., magnetic resonance angiography (MRA), magnetic resonance imaging (MRI), computed tomography (CT), a scanner, an ultrasonic device and the like), a navigation device, a global positioning system (GPS) receiver, an event data recorder (EDR), a flight data recorder (FDR), a vehicle infotainment device, electronic equipment for a ship (e.g., a navigation device for ship, a gyro compass and the like), avionics, a security device, a head unit for a vehicle, an industrial or home robot, an automatic teller machine (ATM) of financial institutions, and a point Of sale (POS) device of shops.

According to some embodiments, the electronic device may include at least one of furniture or a part of a building/structure, an electronic board, an electronic signature receiving device, a projector, and various types of measuring devices (e.g., a water meter, an electricity meter, a gas meter, a radio wave meter and the like) including a projection function. The electronic device according to various embodiments of the present disclosure may be one or a combination of the above described various devices. Further, the electronic device according to various embodiments of the present disclosure may be a flexible device. It is apparent to those skilled in the art that the electronic device according to various embodiments of the present disclosure is not limited to the above described devices.

An electronic device according to various embodiments of the present disclosure will be described with reference to the accompanying drawings. The term “user” used in various embodiments may refer to a person who uses an electronic device or a device (e.g., an artificial intelligence electronic device) which uses an electronic device.

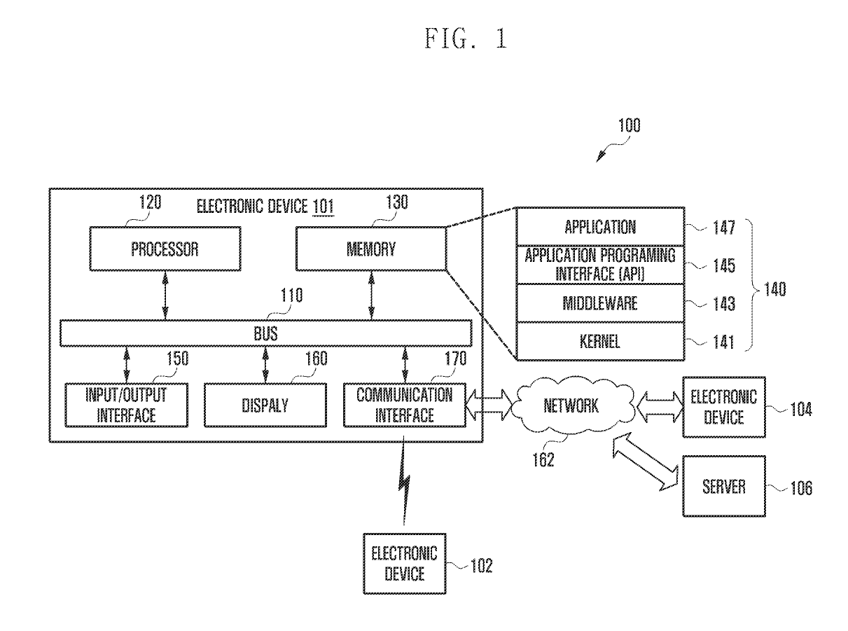

FIG. 1 illustrates a network environment including an electronic device according to various embodiments of the present disclosure.

Referring to FIG. 1, an electronic device 101, in a network environment 100, includes a bus 110, a processor 120, a memory 130, an input/output interface 150, a display 160, and a communication interface 170. According to some embodiment, the electronic device 101 may omit at least one of the components or further include another component.

The bus 110 may be a circuit connecting the above described components and transmitting communication (e.g., a control message) between the above described components.

The processor 120 may include one or more of central processing unit (CPU), application processor (AP) or communication processor (CP). For example, the processor 120 may control at least one component of the electronic device 101 and/or execute calculation relating to communication or data processing.

According to an embodiment of the present disclosure, the processor 120 may analyze an alarm period to wake up an application, and may detect a new application. The processor 120 may determine a reference alarm period, based on a condition set based on the analyzed alarm period. The processor 120 may adjust the alarm period of the application to the reference alarm period. When the reference alarm period is already determined and a new application is detected, the processor 120 may determine a reference alarm period by reflecting the alarm period of the new application. At a point in time for an application to execute a scheduled operation (e.g., a wake-up time point), the processor 120 may wake up an application of which the alarm period is adjusted and an application corresponding to an existing wake-up time point.

The memory 130 may include volatile and/or non-volatile memory. For example, the memory 130 may store command or data relating to at least one component of the electronic device 101. According to some embodiment, the memory may store software and/or program 140. For example, the program 140 may include a kernel 141, middleware 143, an application programming interface (API) 145, and/or an application 147 and so on. At least one portion of the kernel 141, the middleware 143 and the API 145 may be defined as operating system (OS).

According to an embodiment of the present disclosure, the memory 130 may store the alarm schedules of applications installed in the electronic device.

The kernel 141 controls or manages system resources (e.g., the bus 110, the processor 120, or the memory 130) used for executing an operation or function implemented by the remaining other program, for example, the middleware 143, the API 145, or the application 147. Further, the kernel 141 provides an interface for accessing individual components of the electronic device 101 from the middleware 143, the API 145, or the application 147 to control or manage the components.

The middleware 143 performs a relay function of allowing the API 145 or the application 147 to communicate with the kernel 141 to exchange data. Further, in operation requests received from the application 147, the middleware 143 performs a control for the operation requests (e.g., scheduling or load balancing) by using a method of assigning a priority, by which system resources (e.g., the bus 110, the processor 120, the memory 130 and the like) of the electronic device 101 may be used, to the application 147.

The API 145 is an interface by which the application 147 may control a function provided by the kernel 141 or the middleware 142 and includes, for example, at least one interface or function (e.g., command) for a file control, a window control, image processing, or a character control.

The input/output interface 150 may be interface to transmit command or data inputted by a user or another external device to another component(s) of the electronic device 101. Further, the input/output interface 150 may output the command or data received from the another component(s) of the electronic device 101 to the user or the another external device.

The display 160 may include, for example, liquid crystal display (LCD), light emitting diode (LED), organic LED (OLED), or micro electro mechanical system (MEMS) display, or electronic paper display. The display 160 may display, for example, various contents (text, image, video, icon, or symbol, and so on) to a user. The display 160 may include a touch screen, and receive touch, gesture, approaching, or hovering input using a part of body of the user.

The communication interface 170 may set communication of the electronic device 101 and external device (e.g., a first external device 102, a second external device 104, or a server 106). For example, the communication interface 170 may be connected with the network 162 through wireless communication or wire communication and communicate with the external device (e.g., electronic device 104 or server 106).

The wireless communication includes at least one of, for example, Wi-Fi, Bluetooth (BT), near field communication (NFC), a GPS, and cellular communication (e.g., long term evolution (LTE), LTE-advanced (LTE-A), code division multiple access (CDMA), wideband CDMA (WCDMA), universal mobile telecommunications system (UMTS), wireless broadband (WiBro) or global system for mobile communications (GSM)). The wired communication may include at least one of, for example, a universal serial bus (USB), a high definition multimedia interface (HDMI), recommended standard 232 (RS-232), and a plain old telephone service (POTS).

Each of the first external device 102 and the second external device 104 may be same type or different type of device with the electronic device 101. According to some embodiment, the server 106 may include one or more group of servers. According to various embodiment, at least one portion of executions executed by the electronic device may be performed by one or more electronic devices (e.g., external electronic device 102, 104, or server 106). According to some embodiments, when the electronic device 101 should perform a function or service automatically, the electronic device 101 may request performing of at least one function to the another device (e.g., external electronic device 102, 104, or server 106).

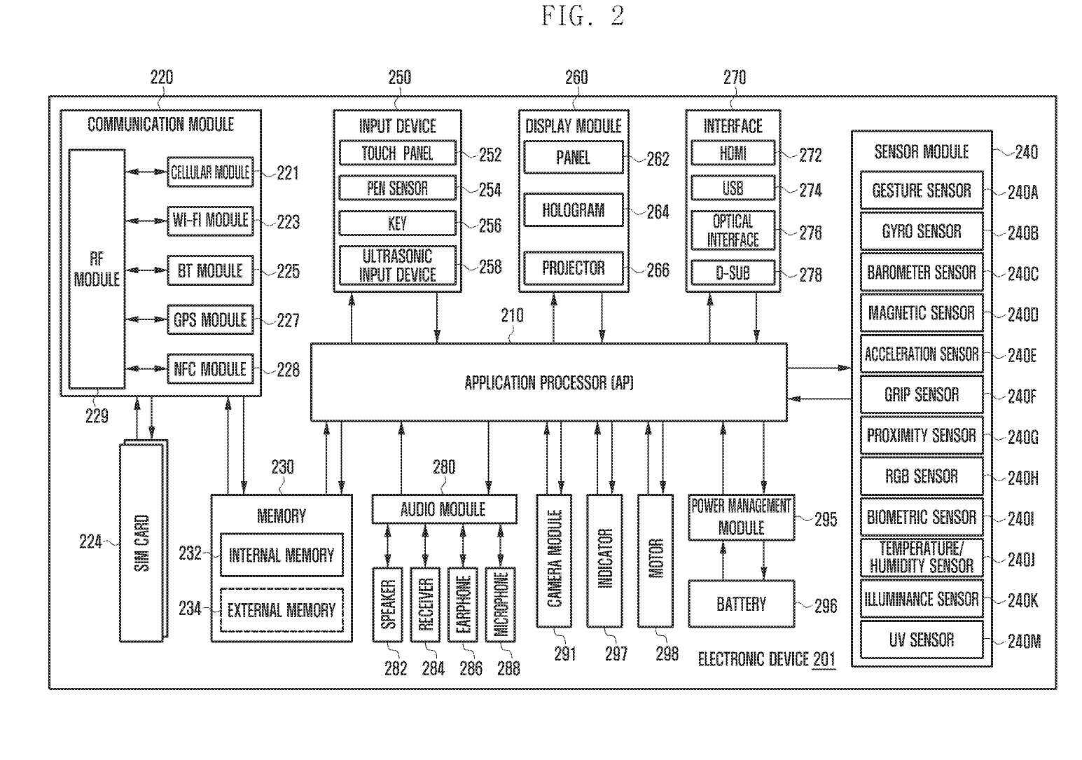

FIG. 2 illustrates a block diagram of an electronic device according to an embodiment of the present disclosure.

Referring to FIG. 2, an electronic device 201 may configure, for example, a whole or a part of the electronic device 101 illustrated in FIG. 1. The electronic device 201 includes one or more APs 210, a communication module 220, a subscriber identification module (SIM) card 224, a memory 230, a sensor module 240, an input device 250, a display 260, an interface 270, an audio module 280, a camera module 291, a power managing module 295, a battery 296, an indicator 297, and a motor 298.

The AP 210 operates an OS or an application program so as to control a plurality of hardware or software component elements connected to the AP 210 and execute various data processing and calculations including multimedia data. The AP 210 may be implemented by, for example, a system on chip (SoC). According to an embodiment, the processor 210 may further include a graphics processing unit (GPU) and/or image signal processor. The AP 210 may include at least one portion of components illustrated in FIG. 2 (e.g., a cellular module 221). The AP 210 may load command or data received from at least one of another component (e.g., non-volatile memory), store various data in the non-volatile memory.

The communication module 220 may include same or similar components with the communication interface 160 of FIG. 1. The communication module 220, for, example, may include the cellular module 221, a Wi-Fi module 223, a BT module 225, a GPS module 227, a NFC module 228, and a radio frequency (RF) module 229.

The cellular module 221 provides a voice, a call, a video call, a short message service (SMS), or an internet service through a communication network (e.g., LTE, LTE-A, CDMA, WCDMA, UMTS, WiBro, GSM and the like). Further, the cellular module 221 may distinguish and authenticate electronic devices within a communication network by using a SIM (e.g., the SIM card 224). According to an embodiment, the cellular module 221 performs at least some of the functions which may be provided by the AP 210. For example, the cellular module 221 may perform at least some of the multimedia control functions. According to an embodiment, the cellular module 221 may include a CP.

Each of the Wi-Fi module 223, the BT module 225, the GPS module 227, and the NFC module 228 may include, for example, a processor for processing data transmitted/received through the corresponding module. Although the cellular module 221, the Wi-Fi module 223, the BT module 225, the GPS module 227, and the NFC module 228 are at least some (e.g., two or more) of the cellular module 221, the Wi-Fi module 223, the BT module 225, the GPS module 227, and the NFC module 228 may be included in one integrated chip (IC) or one IC package according to one embodiment. For example, at least some (e.g., the CP corresponding to the cellular module 221 and the Wi-Fi processor corresponding to the Wi-Fi module 223) of the processors corresponding to the cellular module 221, the Wi-Fi module 223, the BT module 225, the GPS module 227, and the NFC module 228 may be implemented by one SoC.

The RF module 229 transmits/receives data, for example, an RF signal. Although not illustrated, the RF module 229 may include, for example, a transceiver, a power amp module (PAM), a frequency filter, a low noise amplifier (LNA) and the like. Further, the RF module 229 may further include a component for transmitting/receiving electronic waves over a free air space in wireless communication, for example, a conductor, a conducting wire, and the like. Although the cellular module 221, the Wi-Fi module 223, the BT module 225, the GPS module 227, and the NFC module 228 share one RF module 229 in FIG. 2, at least one of the cellular module 221, the Wi-Fi module 223, the BT module 225, the GPS module 227, and the NFC module 228 may transmit/receive an RF signal through a separate RF module according to one embodiment.

The SIM card 224 is a card including a SIM and may be inserted into a slot formed in a particular portion of the electronic device. The SIM card 224 includes unique identification information (e.g., integrated circuit card identifier (ICCID)) or subscriber information (e.g., international mobile subscriber identity (IMSI).

The memory 230 (e.g., memory 130) may include an internal memory 232 or an external memory 234. The internal memory 232 may include, for example, at least one of a volatile memory (e.g., a random access memory (RAM), a dynamic RAM (DRAM), a static RAM (SRAM), a synchronous dynamic RAM (SDRAM), and the like), and a non-volatile Memory (e.g., a read only memory (ROM), a one time programmable ROM (OTPROM), a programmable ROM (PROM), an erasable and programmable ROM (EPROM), an electrically erasable and programmable ROM (EEPROM), a mask ROM, a flash ROM, a not and (NAND) flash memory, a not or (NOR) flash memory, and the like).

According to an embodiment, the internal memory 232 may be a solid state drive (SSD). The external memory 234 may further include a flash drive, for example, a compact flash (CF), a secure digital (SD), a micro-SD, a mini-SD, an extreme digital (xD), or a memory stick. The external memory 234 may be functionally connected to the electronic device 201 through various interfaces. According to an embodiment, the electronic device 201 may further include a storage device (or storage medium) such as a hard drive.

The sensor module 240 measures a physical quantity or detects an operation state of the electronic device 201, and converts the measured or detected information to an electronic signal. The sensor module 240 may include, for example, at least one of a gesture sensor 240A, a gyro sensor 240B, an atmospheric pressure (barometric) sensor 240C, a magnetic sensor 240D, an acceleration sensor 240E, a grip sensor 240F, a proximity sensor 240G, a color sensor 240H (e.g., red, green, and blue (RGB) sensor) 240H, a biometric sensor 240I, a temperature/humidity sensor 240J, an illumination (light) sensor 240K, and a ultraviolet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris sensor, a fingerprint sensor (not illustrated), and the like. The sensor module 240 may further include a control circuit for controlling one or more sensors included in the sensor module 240.

The input device 250 includes a touch panel 252, a (digital) pen sensor 254, a key 256, and an ultrasonic input device 258. For example, the touch panel 252 may recognize a touch input in at least one type of a capacitive type, a resistive type, an infrared type, and an acoustic wave type. The touch panel 252 may further include a control circuit. In the capacitive type, the touch panel 252 may recognize proximity as well as a direct touch. The touch panel 252 may further include a tactile layer. In this event, the touch panel 252 provides a tactile reaction to the user.

The (digital) pen sensor 254 may be implemented, for example, using a method identical or similar to a method of receiving a touch input of the user, or using a separate recognition sheet. The key 256 may include, for example, a physical button, an optical key, or a key pad. The ultrasonic input device 258 is a device which may detect an acoustic wave by a microphone (e.g., a microphone 288) of the electronic device 201 through an input means generating an ultrasonic signal to identify data and may perform wireless recognition. According to an embodiment, the electronic device 201 receives a user input from an external device (e.g., computer or server) connected to the electronic device 201 by using the communication module 220.

The display 260 (e.g., display 160) includes a panel 262, a hologram device 264, and a projector 266. The panel 262 may be, for example, a LCD or an active matrix OLED (AM-OLED). The panel 262 may be implemented to be, for example, flexible, transparent, or wearable. The panel 262 may be configured by the touch panel 252 and one module. The hologram device 264 shows a stereoscopic image in the air by using interference of light. The projector 266 projects light on a screen to display an image. For example, the screen may be located inside or outside the electronic device 201. According to an embodiment, the display 260 may further include a control circuit for controlling the panel 262, the hologram device 264, and the projector 266.

The interface 270 includes, for example, a HDMI 272, an USB 274, an optical interface 276, and a D-subminiature (D-sub) 278. The interface 270 may be included in, for example, the communication interface 170 illustrated in FIG. 1. Additionally or alternatively, the interface 290 may include, for example, a mobile high-definition link (MHL) interface, an SD card/multi-media card (MMC), or an infrared data association (IrDA) standard interface.

The audio module 280 bi-directionally converts a sound and an electronic signal. At least some components of the audio module 280 may be included in, for example, the input/output interface 150 illustrated in FIG. 1. The audio module 280 processes sound information input or output through, for example, a speaker 282, a receiver 284, an earphone 286, the microphone 288 and the like.

The camera module 291 is a device which may photograph a still image and a video. According to an embodiment, the camera module 291 may include one or more image sensors (e.g., a front sensor or a back sensor), an image signal processor (ISP) (not shown) or a flash (e.g., an LED or xenon lamp).

The power managing module 295 manages power of the electronic device 201. Although not illustrated, the power managing module 295 may include, for example, a power management integrated circuit (PMIC), a charger IC, or a battery or fuel gauge.

The PMIC may be mounted to, for example, an integrated circuit or an SoC semiconductor. A charging method may be divided into wired and wireless methods. The charger IC charges a battery and prevent over voltage or over current from flowing from a charger. According to an embodiment, the charger IC includes a charger IC for at least one of the wired charging method and the wireless charging method. The wireless charging method may include, for example, a magnetic resonance method, a magnetic induction method and an electromagnetic wave method, and additional circuits for wireless charging, for example, circuits such as a coil loop, a resonant circuit, a rectifier and the like may be added.

The battery fuel gauge measures, for example, a remaining quantity of the battery 296, or a voltage, a current, or a temperature during charging. The battery 296 may store or generate electricity and supply power to the electronic device 201 by using the stored or generated electricity. The battery 296 may include a rechargeable battery or a solar battery.

The indicator 297 shows particular statuses of the electronic device 201 or a part (e.g., AP 210) of the electronic device 201, for example, a booting status, a message status, a charging status and the like. The motor 298 converts an electrical signal to a mechanical vibration. Although not illustrated, the electronic device 201 may include a processing unit (e.g., GPU) for supporting a module TV. The processing unit for supporting the mobile TV may process, for example, media data according to a standard of digital multimedia broadcasting (DMB), digital video broadcasting (DVB), media flow and the like.

Each of the components of the electronic device according to various embodiments of the present disclosure may be implemented by one or more components and the name of the corresponding component may vary depending on a type of the electronic device. The electronic device according to various embodiments of the present disclosure may include at least one of the above described components, a few of the components may be omitted, or additional components may be further included. Also, some of the components of the electronic device according to various embodiments of the present disclosure may be combined to form a single entity, and thus may equivalently execute functions of the corresponding components before being combined.

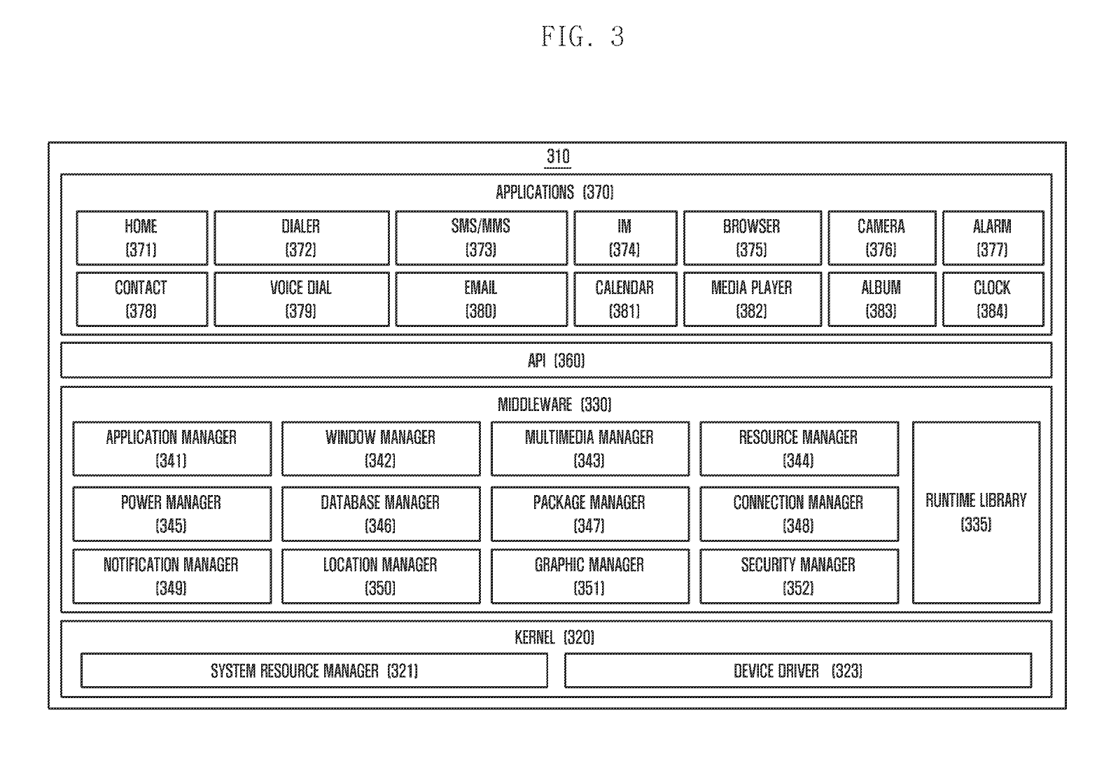

FIG. 3 is a block diagram illustrating a programming module according to an embodiment of the present disclosure.

Referring to FIG. 3, a programming module 310 may be included, e.g. stored, in the electronic apparatus 100, e.g. the memory 130, as illustrated in FIG. 1. At least a part of the programming module 310 may be configured by software, firmware, hardware, and/or combinations of two or more thereof. The programming module 310 may include an OS that is implemented in hardware, e.g., the hardware 200 to control resources related to an electronic device, e.g., the electronic device 100, and/or various applications. e.g., applications 370, driven on the OS. For example, the OS may be Android, iOS, Windows, Symbian, Tizen, Bada, and the like. Referring to FIG. 3, the programming module 310 may include a kernel 320, middleware 330, an API 360, and the applications 370.

The kernel 320, which may be like the kernel 141, may include a system resource manager 321 and/or a device driver 323. The system resource manager 321 may include, for example, a process manager, a memory manager, and a file system manager. The system resource manager 321 may control, allocate, and/or collect system resources. The device driver 323 may include, for example, a display driver, a camera driver, a BT driver, a shared memory driver, a USB driver, a keypad driver, a Wi-Fi driver, and an audio driver. Further, according to an embodiment, the device driver 323 may include an inter-process communication (IPC) driver (not illustrated).

The middleware 330 may include a plurality of modules implemented in advance for providing functions commonly used by the applications 370. Further, the middleware 330 may provide the functions through the API 360 such that the applications 370 may efficiently use restricted system resources within the electronic apparatus. For example, as shown in FIG. 3, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while one of the applications 370 is being executed. According to an embodiment, the runtime library 335 may perform an input/output, memory management, and/or a function for an arithmetic function.

The application manager 341 may manage a life cycle of at least one of the applications 370. The window manager 342 may manage graphical user interface (GUI) resources used by a screen. The multimedia manager 343 may detect formats used for reproduction of various media files, and may perform encoding and/or decoding of a media file by using a codec suitable for the corresponding format. The resource manager 344 may manage resources such as a source code, a memory, and a storage space of at least one of the applications 370.

The power manager 345 may manage a battery and/or power, while operating together with a basic input/output system (BIOS), and may provide power information used for operation. The database manager 346 may manage generation, search, and/or change of a database to be used by at least one of the applications 370. The package manager 347 may manage installation and/or an update of an application distributed in a form of a package file.

For example, the connectivity manager 348 may manage wireless connectivity such as Wi-Fi or BT. The notification manager 349 may display and/or notify of an event, such as an arrival message, a promise, a proximity notification, and the like, in such a way that does not disturb a user. The location manager 350 may manage location information of an electronic apparatus. The graphic manager 351 may manage a graphic effect which will be provided to a user, and/or a user interface related to the graphic effect. The security manager 352 may provide all security functions used for system security and/or user authentication. According to an embodiment, when an electronic apparatus, e.g., the electronic apparatus 100, has a telephone call function, the middleware 330 may further include a telephony manager (not illustrated) for managing a voice and/or video communication function of the electronic apparatus.

The middleware 330 may generate and use a new middleware module through various functional combinations of the aforementioned internal element modules. The middleware 330 may provide modules specialized according to types of OSs in order to provide differentiated functions. Further, the middleware 330 may dynamically remove some of the existing elements and/or add new elements. Accordingly, the middleware 330 may exclude some of the elements described in the various embodiments of the present disclosure, further include other elements, and/or substitute the elements with elements having a different name and performing a similar function.

The API 360, which may be similar to the API 133, is a set of API programming functions, and may be provided with a different configuration according to the OS. For example, in a case of Android or iOS, one API set may be provided for each of platforms, and in a case of Tizen, two or more API sets may be provided.

The applications 370, which may include an application similar to the application 134, may include, for example, a preloaded application and/or a third party application. The applications 370 may include a home application 371 a dialer application 372, a SMS/multimedia messaging service (MMS) application 373, an instant messaging (IM) application 374, a browser application 375, a camera application 376, an alarm application 377, a contact application 378, a voice dial application 379, an email application 380, a calendar application 381, a media player application 382, an album application 383, and a clock application 384. However, the present embodiment is not limited thereto, and the applications 370 may include any other similar and/or suitable application.

At least a part of the programming module 310 may be implemented by commands stored in computer-readable storage media. When the commands are executed by at least one processor, e.g. the processor 210, at least one processor may perform functions corresponding to the commands. The computer-readable storage media may be, for example, the memory 230. At least a part of the programming module 310 may be implemented, e.g. executed, by, for example, the processor 210. At least a part of the programming module 310 may include, for example, a module, a program, a routine, a set of instructions and/or a process for performing at least one function.

The titles of the aforementioned elements of the programming module, e.g. the programming module 310, according to the present disclosure may vary depending on the type of the OS. The programming module according to the present disclosure may include at least one of the aforementioned elements and/or may further include other additional elements, and/or some of the aforementioned elements may be omitted. The operations performed by a programming module and/or other elements according to the present disclosure may be processed through a sequential, parallel, repetitive, and/or heuristic method, and some of the operations may be omitted and/or other operations may be added.

The term “module” used in the present disclosure may refer to, for example, a unit including at least one combination of hardware, software, and firmware. The “module” may be interchangeably used with a term, such as unit, logic, logical block, component, and/or circuit. The “module” may be a minimum unit of an integrally configured article and/or a part thereof. The “module” may be a minimum unit performing at least one function and/or a part thereof. The “module” may be mechanically and/or electronically implemented. For example, the “module” according to the present disclosure may include at least one of an application-specific IC (ASIC) chip, a field-programmable gate arrays (FPGA), and a programmable-logic device for performing operations which has been known and/or are to be developed.

According to various embodiments, at least some of the devices (e.g., modules or functions thereof) or the method (e.g., operations) according to the present disclosure may be implemented by a command stored in a computer-readable storage medium in a programming module form. When the instructions are executed by at least one processor (e.g., the processor 120), the at least one processor may perform functions corresponding to the instructions. The computer-readable storage medium may be, for example, the memory 130. At least a part of the programming module may be implemented (e.g., executed) by, for example, the processor 120. At least some of the programming modules may include, for example, a module, a program, a routine, a set of instructions or a process for performing one or more functions.

The computer-readable recording medium may include magnetic media such as a hard disk, a floppy disk, and a magnetic tape, optical media such as a compact disc ROM (CD-ROM) and a DVD, magneto-optical media such as a floptical disk, and hardware devices specially configured to store and perform a program instruction (e.g., programming module), such as a ROM, a RAM, a flash memory and the like. In addition, the program instructions may include high class language codes, which may be executed in a computer by using an interpreter, as well as machine codes made by a compiler. The aforementioned hardware device may be configured to operate as one or more software modules in order to perform the operation of the present disclosure, and vice versa.

The module or programming module of the present disclosure may include at least one of the aforementioned components with omission of some components or addition of other components. The operations of the modules, programming modules, or other components may be executed in series, in parallel, recursively, or heuristically. Also, some operations may be executed in different order, omitted, or extended with other operations.

Although various embodiments of the present disclosure have been described using specific terms, the specification and drawings are to be regarded in an illustrative rather than a restrictive sense in order to help understand the present disclosure. It is obvious to those skilled in the art that various modifications and changes may be made thereto without departing from the broader spirit and scope of the disclosure.

The electronic device 101 in an embodiment of the present disclosure may periodically wake up, and may execute polling, keep alive, or execute operations as a terminal Polling is an operation in which the electronic device 101 periodically accesses a server and requests a message, and receives a message transmitted from the server in response to the request. The message may include text, images, video, audio, or multimedia, and the like. Also, a point in time that the electronic device 101 periodically accesses a server and requests a message, may be a wake-up time point. The electronic device 101 may be converted into an idle state during an interval between wake-up periods. According to an embodiment of the present disclosure, when a message is received from the server, the electronic device 101 may be converted from an idle state into an active state. An operation in which the electronic device 101 is converted from an idle state into an active state may be defined as a wake-up. For example, in the case of an application that executes polling with respect to the server based on a period of 5 minutes, an alarm period of 5 minutes is registered and the electronic device 101 may wake up based on a period of 5 minutes.

In an embodiment of the present disclosure, a reference alarm period is used to adjust an alarm period of an application. At the time point of the reference alarm period, the electronic device 101 may wake up an application of which an alarm period is adjusted to the reference alarm period. The application may include a social network service (SNS) application such as Facebook, Twitter, and the like, an e-mail service application, an Instant Messenger, a chat service application for a one-to-one chat and a group chat, a message service application such as SMS and MMS, and a widget service application that provides information such as weather, stocks, news, and the like.

Also, in an embodiment of the present disclosure, an idle state may indicate that an active process does not exist and the modules of the electronic device 101 are switched into a sleep state and thus, an amount of current is minimally consumed. The idle state indicates that data is not transmitted or received although a CP of the electronic device 101 is in an active state and a component module of the CP, such as an antenna and the like, is turned on. The active state indicates that an AP and the CP currently operate. For example, when it is time for an alarm based on an alarm period, the electronic device 101 may be converted from an idle state into an active state. In the active state, the electronic device 101 may transmit a single packet to the server or may transmit a plurality of packets in parallel. A difference in an amount of current consumed when the plurality of packets are transmitted in parallel and an amount of current consumed when a single packet is transmitted, may be significantly small.

Accordingly, an alarm controlling method and an electronic device 101 supporting the same according to an embodiment of the present disclosure, may adjust an alarm period that an application basically has (e.g., an alarm period set as a default value or an alarm period set in the application) to the reference alarm period. The electronic device 101 may execute a control to wake up some of applications installed in the electronic device based on an identical period, by correcting the alarm period of the application to the reference alarm period.

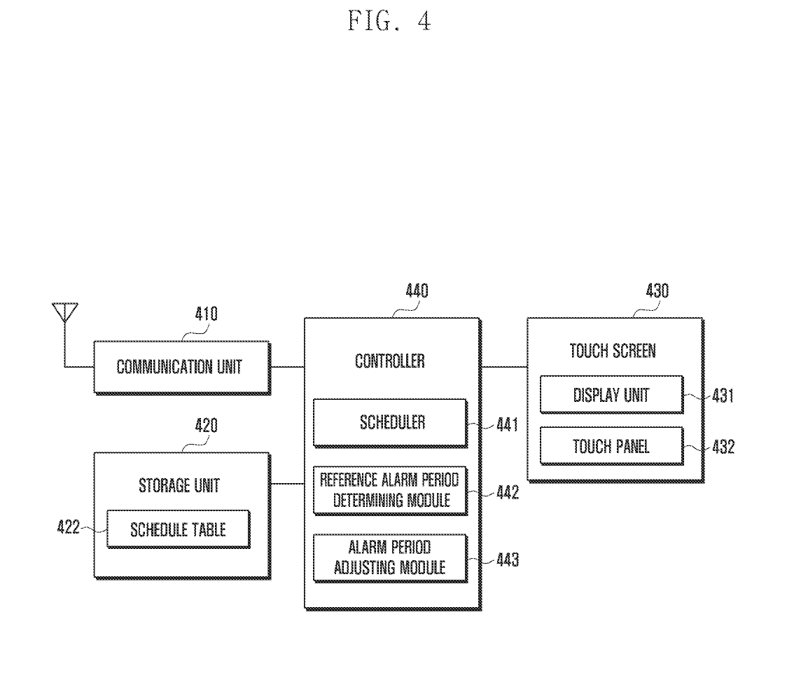

FIG. 4 is a diagram illustrating a configuration of an electronic device according to various embodiments of the present disclosure.

Referring to FIG. 4, the electronic device 101 of the present disclosure may include a communication unit 410, a storage unit 420, a touch screen 430, and a controller 440.

In an embodiment of the present disclosure, under the control of the controller 440, the communication unit 410 may access a server and request a message, and may receive a message transmitted from the server in response to the request.

In an embodiment of the present disclosure, the storage unit 420 may include a schedule table 422.

The schedule table 422 may store collected alarm period information of applications by arranging the collected alarm period information in order of time and the like, under the control of the controller 440.

The touch screen 430 may be configured to integrate a display unit 431 and a touch panel 432. The display unit 431 may display various screens associated with the use of the electronic device 101, under the control of the controller 440.

The controller 440 may control general operations of the electronic device 101 and control a signal flow between internal components of the electronic device 101, or may process data, or control power supply from a battery to the components. At least a part of the controller 440 may be implemented by a processor.

The electronic device 101 that controls an alarm according to various embodiments of the present disclosure may include the communication unit 410 to transmit a packet, the controller 440 that collects alarm period information of at least one application and adjusts the alarm period of the at least one application based on the collected alarm period information, and the storage unit 420 that stores the alarm period information.

The controller 440 may determine a reference alarm period based on at least some of the collected alarm period and a set condition.

The controller 440 may further include a reference alarm period determining module 442 that determines a reference alarm period for an alarm period, based on at least some of the collected alarm period information and the set condition.

When a new application is detected, the reference alarm period determining module 442 analyzes an alarm period of the new application, compares the alarm period of the new application and the reference alarm period, and maintains or redetermines the reference alarm period.

When the alarm period of the new application satisfies the set condition, the reference alarm period determining module 442 redetermines the alarm period of the new application to be the reference alarm period.

The controller 440 may further include an alarm period adjusting module 443 that redetermines the reference alarm period by reflecting a basic alarm period of the new application, and adjusts the basic alarm period of the new application to the redetermined reference alarm period when the basic alarm period that is basically set in the new application is different from the reference alarm period.

The controller 440 may adjust an alarm time point of the at least one application to a starting point of the reference alarm period.

The controller 440 may adjust the alarm time point of the at least one application to the starting point of the reference alarm period when the alarm period of the at least one application is a multiple number of the reference alarm period.

The controller 440 may control the at least one application that is adjusted to the reference alarm period to have an identical alarm time point and an identical alarm period.

The controller 440 may determine the reference alarm period using at least one of an application of which importance is high, an application of which a frequency of use is high, an application of which an alarm period is shortest among the collected alarm period information, and an application of which an alarm period is a median value or an average value among the collected alarm period information, which is the condition set based on the collected alarm period information.

The controller 440 may further include a scheduler 441 that determines or analyzes the collected alarm period of the at least one application, and detects a new application.

The detailed components of the controller 440 will be described in detail. In an embodiment of the present disclosure, the controller 440 may include the scheduler 441, the reference alarm period determining module 442, and the alarm period adjusting module 443.

The scheduler 441 may determine or analyze an alarm period of an application stored in a schedule program 421. Also, the scheduler 441 may detect a new application. The scheduler 441 may arrange the alarm period of the application in order of time, and store the same in the schedule table 422 included in the storage unit 420.

The reference alarm period determining module 442 may determine the reference alarm period based on the condition which is set based on the alarm period of the application that is determined or analyzed by the scheduler 441. In an embodiment of the present disclosure, the set condition may include at least one of an application that a user sets as an important application, an application that a user frequently uses (e.g., an application of which a frequency of use is high), an application of which an alarm period is shortest among the collected alarm period information, and an application of which an alarm period is a median value or an average value among the collected alarm period information. The reference alarm period determining module 442 may transfer the determined reference alarm period to the alarm period adjusting module 443.

According to an embodiment of the present disclosure, when the reference alarm period is already determined and a new application is detected by the scheduler 441, the reference alarm period determining module 442 may determine whether to maintain or change the reference alarm period determined based on the set condition. For example, when an alarm period (i.e., a basic alarm period) that is basically set in the new application is different from the reference alarm period, the reference alarm period determining module 442 may determine the reference alarm period by reflecting the basic alarm period of the new application.

The alarm period adjusting module 443 may selectively adjust an alarm period to wake up each of the applications, so as to increase the available time of an electronic device 101. For example, when the basic alarm period of the application and the reference alarm period are different, the alarm period adjusting module 443 may adjust the basic alarm period of the application to the reference alarm period.

According to an embodiment of the present disclosure, when the basic alarm period of the new application is identical to the reference alarm period, the alarm period adjusting module 443 may not execute an operation of adjusting the basic alarm period to the reference alarm period.

According to an embodiment of the present disclosure, when the electronic device 101 is activated (e.g., at a wake-up time point), the electronic device 101 may wake up an application of which alarm period is adjusted through the alarm period adjusting module 443 and an application corresponding to an existing alarm time point. Also, according to an embodiment of the present disclosure, some of the applications may transmit a packet to a server based on an adjusted alarm schedule.

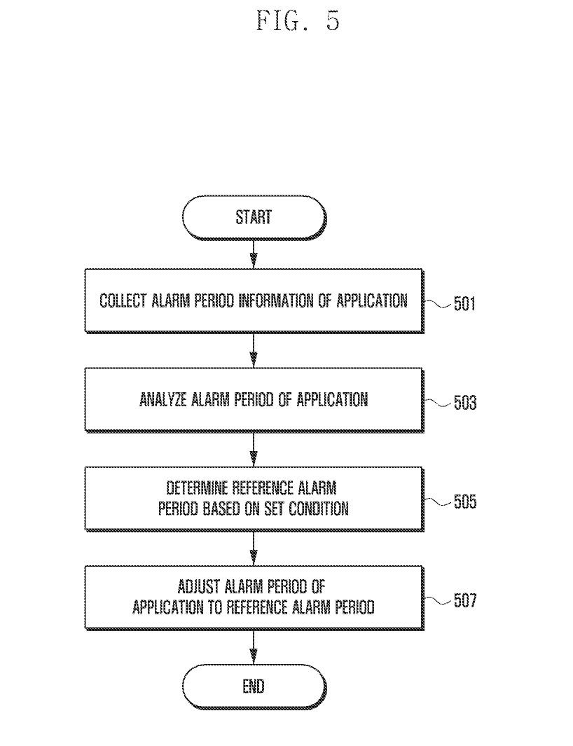

FIG. 5 is a flowchart illustrating an alarm controlling method according to various embodiments of the present disclosure.

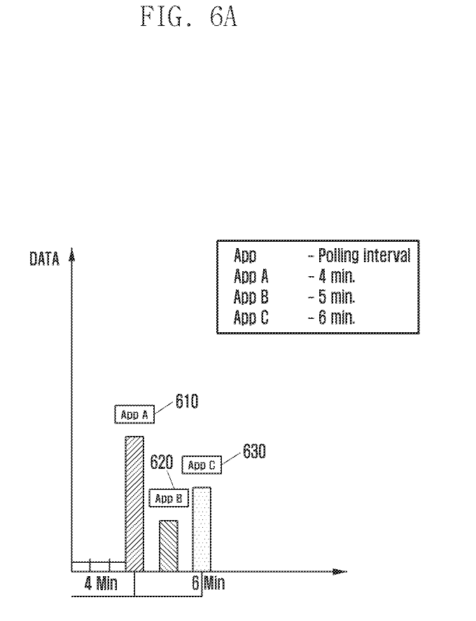

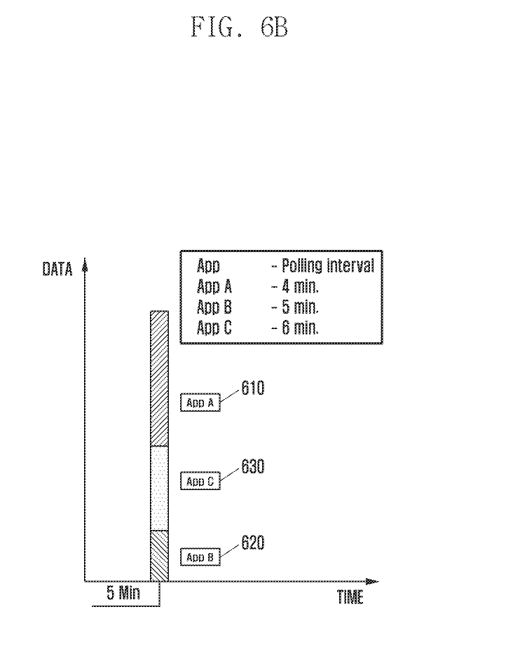

FIGS. 6A and 6B are diagrams illustrating an alarm controlling method according to various embodiments of the present disclosure.

Referring to FIGS. 5, 6A and 6B, the controller 440 may collect alarm period information of applications in operation 501. Some of the applications may periodically wake up, or may periodically transmit a packet to a server. The controller 440 may collect the alarm period information of the applications, so as to configure the schedule table 422. The schedule table 422 may be a time table in which the alarm periods of the applications are arranged in order of time and the like.

For example, as shown in the graph on FIG. 6A, the controller 440 may configure the schedule table 422 by collecting application A 610 having an alarm period of 4 minutes for wake-up, application B 620 having an alarm period of 5 minutes, and application C 630 having an alarm period of 6 minutes.

The controller 440 may determine or analyze the alarm periods of the applications stored in the schedule table 422, through the scheduler 441. For example, the controller 440 may determine, through the scheduler 441, that application A 610 wakes up based on a period of 4 minutes, application B 620 wakes up based on a period of 5 minutes, and application C 630 wakes up based on a period of 6 minutes. When it is assumed that application A 610, application B 620, and application C 630 transmit packets to a server at an identical point in time, for example, 10 o'clock, application A 610 may be scheduled to execute polling at 10:04, application B 620 may be scheduled to execute polling at 10:05, and application C630 may be scheduled to execute polling at 10:06 in the schedule table 422. An embodiment of the present disclosure will be described by assuming that polling is executed as an application wakes up. In this instance, each of applications A, B, and C wakes up and executes polling successfully three times, at 10:04, 10:05, and 10:06, and thus, an amount of current consumed in an electronic device 101 may be high.

Based on the determined or analyzed alarm periods, the controller 440 may determine a reference alarm period based on a set condition in operation 505. In an embodiment of the present disclosure, the set condition may include at least one of an application that a user sets as an important application, an application that a user frequently uses (e.g., an application of which a frequency of use is high), an application of which an alarm period is shortest among the collected alarm period information, and an application of which an alarm period is a median value or an average value among the collected alarm period information.

For example, descriptions will be provided by assuming that an application having an alarm period of 4 minutes, an application having an alarm period of 5 minutes, and an application having an alarm period of 6 minutes are stored in the schedule table 422. When the set condition corresponds to an alarm period of an application, which corresponds to a median value among the collected alarm period information, the controller 440 may determine an alarm period of an application that has an alarm period corresponding to a median value from among applications having alarm periods of 4 minutes, 5 minutes, and 6 minutes, to be the reference alarm period. Alternatively, when the set condition is an application having the shortest alarm period, the controller 440 may determine an alarm period of an application that has an alarm period of 4 minutes, which is the shortest alarm period, to be the reference alarm period. For example, the reference alarm period may be dynamically changed based on the set condition, under the control of the controller 440.

Descriptions will be provided by assuming that the reference alarm period determined based on the set condition is a period of 5 minutes.

When the reference alarm period is determined in operation 505, the controller 440 may adjust an alarm period of an application to the reference alarm period in operation 507. For example, when the reference alarm period is determined to be a period of 5 minutes, the controller 440 may adjust, to the reference alarm period of 5 minutes, the alarm period of application A 610 having an alarm period of 4 minutes and the alarm period of application C 630 having an alarm period of 6 minutes. In other words, the controller 440 may adjust the alarm period of application A 610 having an alarm period of 4 minutes to a period of 5 minutes, so that application A 610 may wake up 1 minute later than before. Additionally, the controller 440 may adjust the alarm period of application C 630 having an alarm period of 6 minutes to a period of 5 minutes, so that application C 630 may wake up 1 minute earlier than before.

According to various embodiments of the present disclosure, by adjusting the alarm periods to the reference alarm period, the controller 440 may execute a control to wake up the electronic device 101 a fewer number of times than before. For example, the controller 440 may execute a control to wake up applications at an identical point in time and based on an identical period, which had woken up at different points in time and based on different periods.

The controller 440 may transmit, to the server, the packets of some of the applications of which alarm periods are adjusted to the reference alarm period, at a wake-up time point. For example, at the wake-up time point (e.g., at the 5th-minute that is an alarm time point), the controller 440 may transmit the packets of application B 620 which used to have a period of 5 minutes, and an application of which an alarm period is adjusted to a period of 5 minutes (e.g., application A 610 having a period of 4 minutes and application C 630 having a period of 6 minutes). In other words, as illustrated in the diagram on FIG. 6B, the controller 440 may transmit the packets of application A 610, application B 620, and application C 630 to the server based on a period of 5 minutes.

According to an embodiment of the present disclosure, the controller 440 may maintain the determined reference alarm period when a new application is not detected or the reference alarm period is not changed by the set condition.

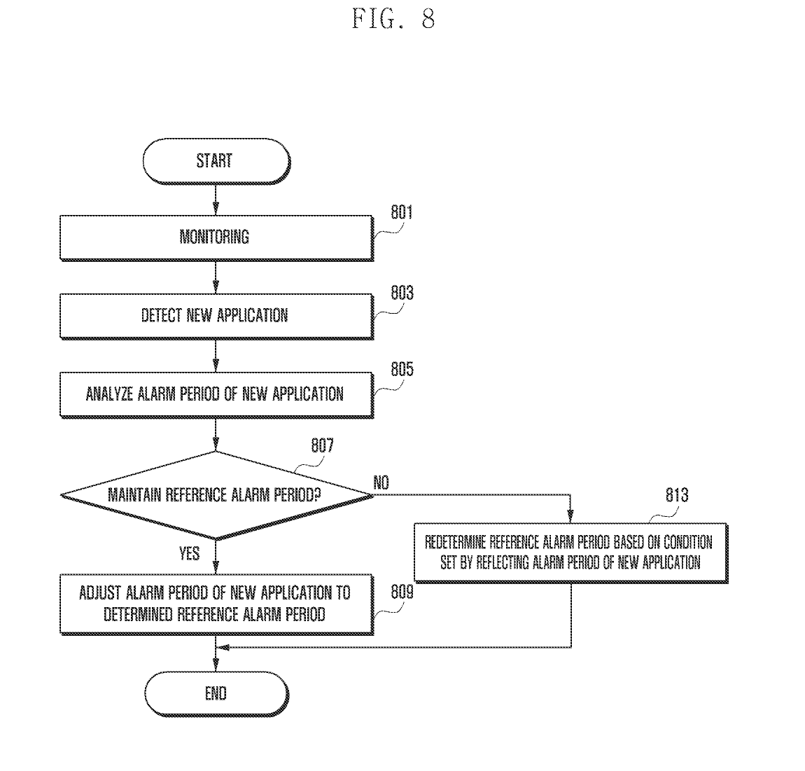

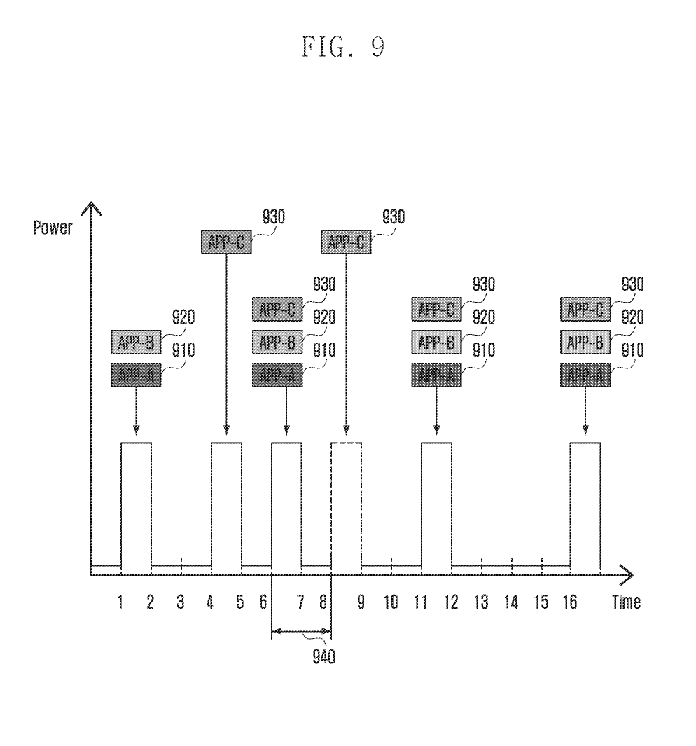

According to an embodiment of the present disclosure, the application of which the alarm period has been adjusted to a period of 5 minutes may maintain the period of 5 minutes, when the reference alarm period is not changed. However, the present disclosure may not be limited thereto, and when a new application is detected in FIGS. 8 and 9 described below, the controller 440 may redetermine the reference alarm period. The controller 440 may compare the new application and the reference alarm period, and may determine an alarm period that satisfies the set condition to be a reference alarm period. For example, when the new application satisfies the set condition, the controller 440 may redetermine the reference alarm period based on the condition set by reflecting the alarm period of the new application. The reference alarm period may be redetermined based on the alarm period of the new application, or may be redetermined based on an average value of the alarm periods of the new application and existing applications. When the reference alarm period is redetermined based on the set condition by reflecting the alarm period of the new application, the controller 440 may readjust the alarm period of the new application or the alarm periods of the applications of which the alarm periods have been adjusted, to the redetermined reference alarm period. Alternatively, when the determined alarm period satisfies the set condition, the controller 440 may maintain the determined reference alarm period.

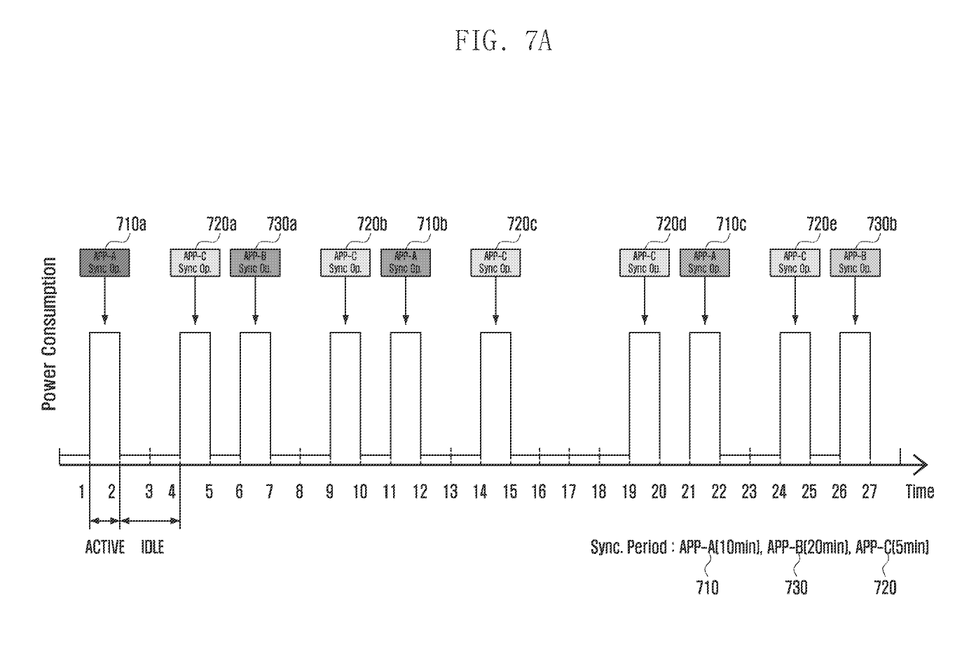

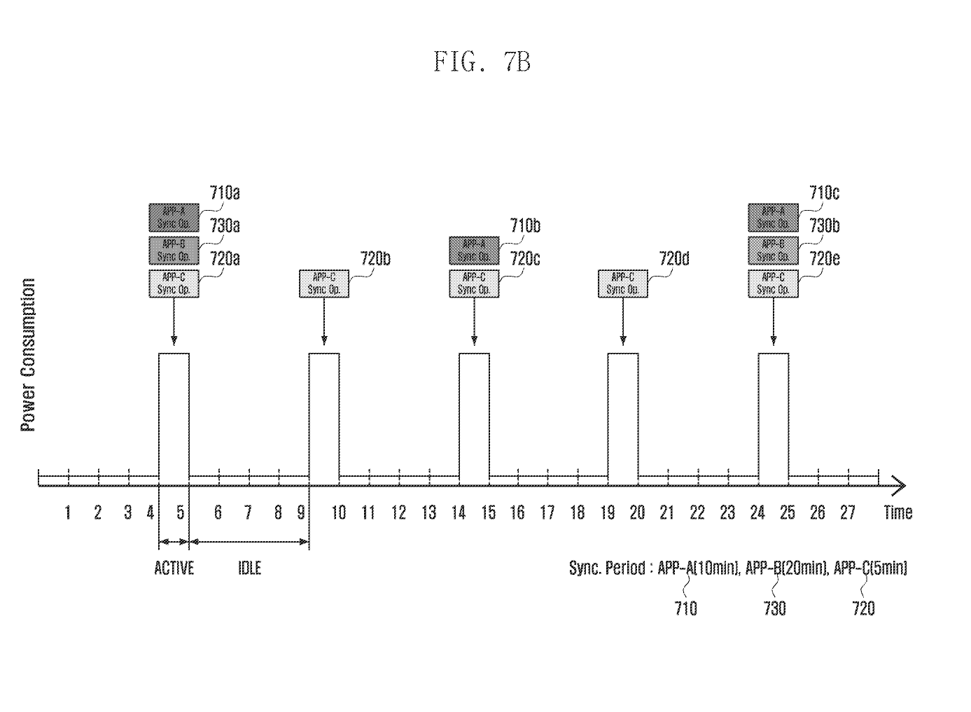

FIGS. 7A and 7B are diagrams illustrating an alarm period controlling method according to various embodiments of the present disclosure.

Referring to FIGS. 7A and 7B, An embodiment of the present disclosure will be described by assuming that application A 710, application B 730, and application C 720 wake up, respectively, based on a period of 10 minutes, a period of 20 minutes, and a period of 5 minutes, so as to transmit a packet to a server.

Referring to FIG. 7A, the electronic device 101 may wake up 10 times (that is, 710a, 720a, 730a, 720b, 710b, 720c, 720d, 710c, 720e, and 730b) during 28 minutes, as a wake-up time point is detected.

According to an alarm controlling method of various embodiments of the present disclosure, a reference alarm period may be determined to be 5 minutes. In this instance, when an alarm period of an application is a multiple number of the reference alarm period, the controller 440 may adjust only a starting point of the alarm period of the application. In other words, the controller 440 may adjust a wake-up starting point of the application to a starting point of the reference alarm period. For example, the controller 440 may adjust the wake-up starting point of the application to the starting point of the alarm period of 5 minutes, which is the reference alarm period.

Referring to FIG. 7B, in the case of the applications having a period of 10 minutes and a period of 20 minutes, the alarm periods are multiple numbers of 5 minutes, which is the reference alarm period, and thus, the controller 440 may adjust the starting points of the alarm periods of application A 710 and application B 730 to the starting point of the alarm period of application C 720 which has a period of 5 minutes.

After adjusting the starting point of the alarm period, each application may transmit a packet to the server based on a corresponding alarm period (e.g., a period of 10 minutes in the case of application A 710 and a period of 20 minutes in the case of application B 730).

According to an embodiment of the present disclosure, the controller 440 may adjust the starting points of the alarm periods of application A 710 and application B 730, based on application C 720 which starts transmission of a packet at the 4th minute based on a period of 5 minutes. For example, at the 4th minute, which is the alarm time point of the application C 720, the controller 440 may wake up application A 710a, application B 730a, and application C 720a, so as to transmit a packet. At the 9^{th} minute which is a subsequent alarm time point, the controller 440 may wake up application C 720b to transmit a packet. At the 14^{th} minute which is a subsequent alarm time point, the controller 440 may wake up application A 710b and application C 720c, so as to transmit a packet. Subsequently, at the 19^{th} minute which is a subsequent alarm time point, the controller 440 may wake up application C 720d to transmit a packet. Subsequently, at the 24^{th} minute which is a subsequent alarm time point, the controller 440 may wake up application A 710c, application B 730b, and application C 720e, so as to transmit a packet.

The comparison between the packet transmission executed based on the reference alarm period as illustrated in FIG. 7A and the packet transmission executed by adjusting the alarm time points as illustrated in FIG. 7B, shows that the electronic device 101 wakes up 10 times during 28 minutes in FIG. 7A, whereas the electronic device wakes 101 up 5 times during the 28 minutes in FIG. 7B. In other words, the controller 440 may adjust an alarm period of an application so that the number of times that the electronic device 101 wakes up during the 28 minutes may be reduced from 10 times to 5 times.

FIG. 8 is a flowchart illustrating an alarm period controlling method according to various embodiments of the present disclosure.

Referring to FIG. 8, the controller 440 may execute monitoring in operation 801. Monitoring may be executed by the scheduler 441. Through monitoring, the controller 440 may detect a new application in operation 803. However, the present disclosure may not be limited thereto, and a new application may not be detected through monitoring. Descriptions will be provided by assuming that a new application is detected in FIG. 8. The new application may be an application that is downloaded from an online market and is installed in the electronic device. Operation 803 may include the case in which a new application is installed in the electronic device, the case in which packet transmission of the new application is detected, or the case in which the new application registers an alarm for wake-up.

When the new application is detected, the controller 440 analyzes an alarm period of the new application in operation 805.

The controller 440 may determine whether to maintain the determined reference alarm period in operation 807. According to an embodiment of the present disclosure, whether to maintain the determined reference alarm period may be determined based on a condition set based on the alarm period of the new application and the determined reference alarm period.

For example, when the determined reference alarm period satisfies the set condition, the controller 440 may maintain the determined reference alarm period. Alternatively, when the alarm period of the new application satisfies the set condition, the controller 440 may change the reference alarm period from the determined reference period to the alarm period of the new application.

According to an embodiment of the present disclosure, when the determined reference alarm period is maintained, the controller 440 may adjust the alarm period of the new application to the determined reference alarm period in operation 809. In other words, the controller 440 may maintain the determined reference alarm period. However, the present disclosure may not be limited thereto, and the controller 440 may not execute the operation of adjusting the alarm period of the new application to the reference alarm period. For example, this may be applied when the alarm period of the new application and the reference alarm period are identical.

Alternatively, when the determined reference alarm period is not maintained in operation 807, the controller 440 in operation 813 may redetermine the reference alarm period based on the condition set by reflecting the alarm period of the new application. The condition for redetermination may be variously set. For example, the reference alarm period may be redetermined based on the alarm period of the new application or may be redetermined based on an average value of alarm periods of the new application and existing applications, and various other conditions may be set.

FIG. 9 is a diagram illustrating an alarm controlling method according to various embodiments of the present disclosure.

Referring to FIG. 9, the controller 440 may determine registration of an alarm of a new application, or may determine a wake-up of the new application C 930 at the 4^{th} minute. After the determination, the controller 440 may analyze the alarm period of application C 930. Descriptions will be provided by assuming that the alarm period of application C 930 is a period of 4 minutes. Application C 930 has transmitted a packet at the 4^{th} minute and thus, a subsequent packet transmission is scheduled at the 8^{th} minute, which is 4 minutes after the 4^{th} minute. Application A 910 and application B 920 of which alarm periods are adjusted to a reference alarm period (e.g., 5 minutes) have transmitted packets at the 1st minute, and thus, the controller 440 may control a subsequent packet transmission to be executed at the 6^{th} minute, which is 5 minutes after the 1^{st} minute. Application C 930 is scheduled to transmit a packet at the 8^{th} minute. However, the alarm period of application C 930 is adjusted to a period of 5 minutes which is the reference alarm period and thus, may be scheduled to transmit a packet at the 6^{th} minute or 11^{th} minute. For example, the controller 440 may transmit the packets of application A 910, application B 920, and application C 930 at the 6^{th} minute. In other words, the controller 440 may execute a control to adjust the alarm period of application C 930, which is scheduled to transmit a packet at the 8^{th} minute, to a period of 5 minutes, so that application C 930 wakes up and transmits a packet at the 6^{th} minute. Also, the controller 440 may adjust the alarm period of application C 930 from a period of 4 minutes to a period of 5 minutes. Since the packet is transmitted at the 6^{th} minute as the period is adjusted to a period of 5 minutes, the controller 440 may transmit the packets of application A 910, application B 920, and application C 930 to the server at the 11^{th} minute, which is 5 minutes after the 6^{th} minute. Subsequently, the controller 440 may transmit the packets of application A 910, application B 920, and application C 930 at the 16^{th} minutes, which is 5 minutes after the 11th minute.

According to another embodiment of the present disclosure, the controller 440 may transmit a packet of the new application C 930 at the 4th minute as a wake-up of the new application C 930 is detected at the 4th minute. After the packet transmission, the controller 440 may analyze the alarm period of application C930. The controller 440 may compare the determined reference alarm period (e.g., 5 minutes) and the alarm period of application C 930. When a result of the comparison shows that application C 930 of which the alarm period of 4 minutes satisfies a set condition, the reference alarm period may be adjusted to 4 minutes. Accordingly, the alarm periods of the applications of which alarm periods have been adjusted to 5 minutes (e.g., application A 910 and application B 920) may be readjusted to a period of 4 minutes.

According to an alarm controlling method according to various embodiments, the method may include collecting alarm period information of at least one application, determining a reference alarm period for an alarm period, based on the collected alarm period information, and adjusting the alarm period of the at least one application to the reference alarm period.

The operation of determining the reference alarm period may determine the reference alarm period based on at some of the collected alarm period information and a set condition.

According to an embodiment of the present disclosure, when the new application is detected, the method may further include analyzing an alarm period of a new application, comparing the alarm period of the new application and the reference alarm period, and maintaining or redetermining the reference alarm period.

The operation of maintaining or redetermining may further include redetermining the alarm period of the new application to be the reference alarm period when the alarm period of the new application satisfies the set condition.

The operation of maintaining or redetermining may further include redetermining the reference alarm period by reflecting a basic alarm period of the new application, and adjusting the basic alarm period of the new application to the redetermined reference alarm period when the basic alarm period that is basically set in the new application is different from the reference alarm period.

The operation of adjusting to the reference alarm period may further include adjusting an alarm time point of the at least one application to a starting point of the reference alarm period. When the alarm period of the at least one application is a multiple number of the reference alarm period, the method may adjust an alarm time point of the at least one application to a starting point of the reference alarm period

The at least one application that is adjusted to the reference alarm period, may have an identical alarm starting point and an identical alarm period.

The set condition may include at least one of an application of which importance is high, an application of which a frequency of use is high, an application of which an alarm period is shortest among the collected alarm period information, and an application of which an alarm period is a median value or an average value among the collected alarm period information.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of controlling an alarm of an electronic device, the method comprising:
collecting alarm period information of at least one application;
determining a reference alarm period for an alarm period, based on the collected alarm period information; and
adjusting the alarm period of the at least one application to the reference alarm period.

2. The method of claim 1, wherein the determining of the reference alarm period comprises:
determining the reference alarm period based on at some of the collected alarm period information and a set condition.

3. The method of claim 2, further comprising:
analyzing an alarm period of a new application when the new application is detected;
comparing the alarm period of the new application and the reference alarm period; and
maintaining or redetermining the reference alarm period.

4. The method of claim 3, wherein the maintaining or redetermining further comprises:
redetermining the alarm period of the new application to be the reference alarm period when the alarm period of the new application satisfies the set condition.

5. The method of claim 3, wherein the maintaining or redetermining comprises:
when a basic alarm period that is basically set in the new application is different from the reference alarm period, redetermining the reference alarm period by reflecting the basic alarm period of the new application; and
adjusting the basic alarm period of the new application to the redetermined reference alarm period.

6. The method of claim 1, wherein the adjusting to the reference alarm period further comprises:
adjusting an alarm starting point of the at least one application to a starting point of the reference alarm period.

7. The method of claim 1, further comprising:
adjusting, when the alarm period of the at least one application is a multiple number of the reference alarm period, an alarm time point of the at least one application to a starting point of the reference alarm period.

8. The method of claim 1, wherein the at least one application that is adjusted to the reference alarm period, has an identical alarm starting point and an identical alarm period.

9. The method of claim 2, wherein the set condition includes at least one of an application of which importance is high, an application of which a frequency of use is high, an application of which an alarm period is shortest among the collected alarm period information, and an application of which an alarm period is a median value or an average value among the collected alarm period information.

10. An electronic device comprising:
a communication unit configured to transmit and receive a packet;
a controller configured to:
collect alarm period information of at least one application, and
adjust an alarm period of the at least one application based on the collected alarm period information; and
a storage unit configured to store the alarm period information.

11. The electronic device of claim 10, wherein the controller is further configured to determine a reference alarm period, based on at least some of the collected alarm period information and a set condition.

12. The electronic device of claim 11, wherein the controller further comprises:
a reference alarm period determining module to determine a reference alarm period for an alarm period, based on at least some of the collected alarm period information and a set condition.

13. The electronic device of claim 12, wherein the reference alarm period determining module analyzes an alarm period of a new application when the new application is detected, compares the alarm period of the new application and the reference alarm period, and maintains or redetermines the reference alarm period.

14. The electronic device of claim 13, wherein, the reference alarm period determining module redetermines the alarm period of the new application to be the reference alarm period when the alarm period of the new application satisfies the set condition.

15. The electronic device of claim 13, wherein the controller further comprises:
an alarm period adjusting module to redetermine the reference alarm period by reflecting a basic alarm period of the new application, and to adjust the basic alarm period of the new application to the redetermined reference alarm period, when the basic alarm period that is basically set in the new application is different from the reference alarm period.

16. The electronic device of claim 11, wherein the controller is further configured to adjust an alarm starting point of the at least one application to a starting point of the reference alarm period.

17. The electronic device of claim 11, wherein the controller is further configured to execute a control to adjust an alarm time point of the at least one application to a starting point of the reference alarm period when the alarm period of the at least one application is a multiple number of the reference alarm period.

18. The electronic device of claim 11, wherein the controller is further configured to execute a control to enable the at least one application that is adjusted to the reference alarm period, to have an identical alarm time point and an identical alarm period.

19. The electronic device of claim 11, wherein the controller is further configured to execute a control to determine the reference alarm period using at least one of an application of which importance is high, an application of which a frequency of use is high, an application of which an alarm period is shortest among the collected alarm period information, and an application of which an alarm period is a median value or an average value among the collected alarm period information, which is the condition set based on the collected alarm period information.

20. The electronic device of claim 10, wherein the controller further comprises:
a scheduler to determine or analyze the collected alarm period of the at least one application, and to detect a new application.
